(19) United States
(12) Patent Application Publication
(10) Pub. No.: US 2006/0213922 A1
(43) Pub. Date: Sep. 28, 2006

(54) Dispensing device for foodstuff, in particular ice cream

(75) Inventors: Matthias Lodter, Büchenbach (DE); Sven Distler, Rednitzhembach (DE); Wolfgang Lengenfelder, Nurnberg (DE)

Correspondence Address: BELL, BOYD & LLOYD LLC, P. O. BOX 1135, CHICAGO, IL, 60690-1135, US

(73) Assignee: Nestec S.A., Vevey (CH)

(21) Appl. No.: 10/556,854

(22) PCT Filed: Nov. 4, 2003
(86) PCT No.: PCT/EP03/12297

§ 371 Date: Nov. 14, 2005

(30) Foreign Application Priority Data
May 28, 2003 (DE) 203 08 396.2

(51) Int. Cl. G07F 9/10; G07F 11/04

(52) U.S. Cl. 221/150 HC

(57) ABSTRACT

The invention relates to a dispensing device for a foodstuff, in particular ice cream, having a holder for a receiving container for the foodstuff, and a support for the holder. In order to facilitate the positioning and removal of the receiving container in the delivery position, the holder is connected to a support by an adjusting device, and the holder can be moved in the adjusting device between a delivery position for delivering the foodstuff and an intermediate position for inserting the receiving container into and removing it from the holder.

### BACKGROUND

The invention relates to a dispensing device for a portioned foodstuff in accordance with the precharacterizing clause of claim 1.

In order to provide portioned foodstuffs, dispensing appliances are known, in which a user can obtain a portion of the foodstuff by operation of the dispensing appliance. The foodstuff may be a solid or flowable or pasty foodstuff. The invention is suitable in particular for ice cream or the like, for example whipped cream or else portioned liquids.

An essential feature of the dispensing device of the generic type is that the operator has to transport the receiving container into a delivery position in which the delivery of the foodstuff can take place. In this case, the insertion of the receiving container in the delivery position is difficult because the construction of the holder and of further parts of the dispensing device in the region of the delivery position creates constricted spatial conditions. Relatively great attentiveness and skill is therefore needed for the operator in order to insert the receiving container in the delivery position into the dispensing device. In addition, this insertion is made difficult by the fact that the construction of the dispensing device requires that the delivery position be at a certain distance from the operating side of the dispensing device and this distance makes it even more difficult to insert the receiving container in the transfer position.

A dispensing device of the previously described type has also already been proposed, in which different receiving containers are to be inserted and to be removed in two delivery positions arranged one above the other. This dispensing device is set up in the region of the upper delivery position to receive a storage container for the foodstuff, the storage container being a package or casing which is filled with a certain foodstuff and which the operator chooses before the operation and has to insert into the delivery position. The foodstuff may be, for example, a certain type of ice cream with which the package is filled. In the region of the lower delivery position, the dispensing device is set up for the purpose of receiving a second receiving container, for example an ice-cream cone, into which the foodstuff in the storage container is transferred, for example by the foodstuff in the storage container being pushed out of the storage container by a ram and being conveyed into the receiving container. This dispensing device has the previously described difficulties with inserting and removing the first receiving container (package) and/or also the second receiving container (ice-cream cone).

### SUMMARY

The invention provides a dispensing device of the present type in such a manner that the insertion and removal of the receiving container into and from the delivery position is easy.

In the dispensing device according to the invention, the holder is connected to the support by an adjusting device and can be moved in the adjusting device between the delivery position for delivering the foodstuff and a removal position for inserting the receiving container into and removing it from the holder. This makes it possible not to insert the receiving container in the delivery position, but rather in an intermediate position which is offset horizontally with respect to the latter and into which the insertion is simpler and easier because of the offset with respect to the delivery position, with the result that the operator can insert the receiving container into the holder with less attentiveness. This simpler and easier handling also arises when removing the receiving container from the dispensing device because the removal can also take place from the intermediate position which is offset horizontally with respect to the delivery position, this being able to take place in a simpler manner and with less attentiveness compared to the insertion of the receiving container into the intermediate position prior to it being moved together with the support into the delivery position.

The intermediate position can be offset with respect to the delivery position towards a region which surrounds the delivery position in a curved manner from one side of the dispensing device over the front operating side towards the other side. In this region, the intermediate position can be offset laterally and also towards the operating side and also obliquely thereto. In all of these possible positions, the intermediate position is more easily accessible to the operator, as a result of which the previously described advantages when inserting the receiving container into and removing it from the intermediate position arise.

A direction of movement which is arched in a curved manner between the intermediate position and the delivery position is particularly suitable, specifically, in particular, if the arching axis or axis of rotation of the curved direction of movement is offset with respect to the delivery position towards the operating side and at the same time laterally. This makes it possible to arrange a hinge, which makes the curved movement possible, between the holder and the support offset with respect to the delivery position towards the operating side and at the same time laterally. For structural reasons and for reasons concerned with using the given space, the rotary hinge can be arranged favourably in this position and with simple refinements. It should be taken into consideration here that a clearance is required on the section of movement between the intermediate position and the delivery position, in which the receiving container, which is held by the holder, can be moved.

An annular body is particularly suitable for the holder, the internal cross-sectional dimension of which forms a receiving opening for the receiving container, with the result that the latter can be introduced from above into the annular body. In this case, the inner, upper edge of the annular body can form a resting element on which the receiving container rests with an outer flange on its upper edge and is thereby prevented from slipping through the holder. In order to ensure an easy-to-handle and secure grasping of the receiving container for removing the receiving container from the holder, two gripping clearances are provided in the upper side of the holder, the said clearances being arranged lying opposite each other and in which two fingers of an operating hand can be placed and can easily and securely grasp the receiving container. If the adjusting device has a direction of movement which is curved in the form of a circular arch, it is advantageous to provide, in the upper side of the holder, two further gripping clearances on the upper side of the holder which, with respect to the previously described gripping clearances, are arranged rotated through an angle which corresponds approximately to the angle about which the holder rotates as it moves from the delivery position into the intermediate position. In this refinement, the receiving container can also be grasped in an easy-to-handle manner in the intermediate position.

The developments of the invention likewise improve the accessibility and handling when the operator operates the dispensing device, simple and small refinements which can be produced cost-effectively and which furthermore ensure reliable functioning also being obtained.

Additional features and advantages are described herein, and will be apparent from, the following Detailed Description and the figures.

### BRIEF DESCRIPTION OF THE FIGURES

FIG. 1 shows a lower part of a dispensing appliance with a dispensing device according to the invention in a perspective front view,

FIG. 2 shows the dispensing device in a perspective front view,

FIG. 3 shows a support of the dispensing device in a perspective front view from above,

FIG. 4 shows the support in a perspective front view from below.

### DETAILED DESCRIPTION

The dispensing appliance, which is referred to in its entirety by 1, is a free-standing appliance which can be placed onto a standing surface 2 or the like and has a base 3 and a housing 4 which extends upwards from the said base and on whose front side 6, which faces the operating side 5, a dispensing device 7 for dispensing a foodstuff in portions, in particular ice cream, is arranged. The dispensing device 7 is situated below an upper, front projection 8 of the housing 4, the lower side of which is referred to by 8a, and is therefore situated in the region of a front recess 9 of the housing 4, which recess is arranged below the projection 8 and can extend continuously downwards, for example.

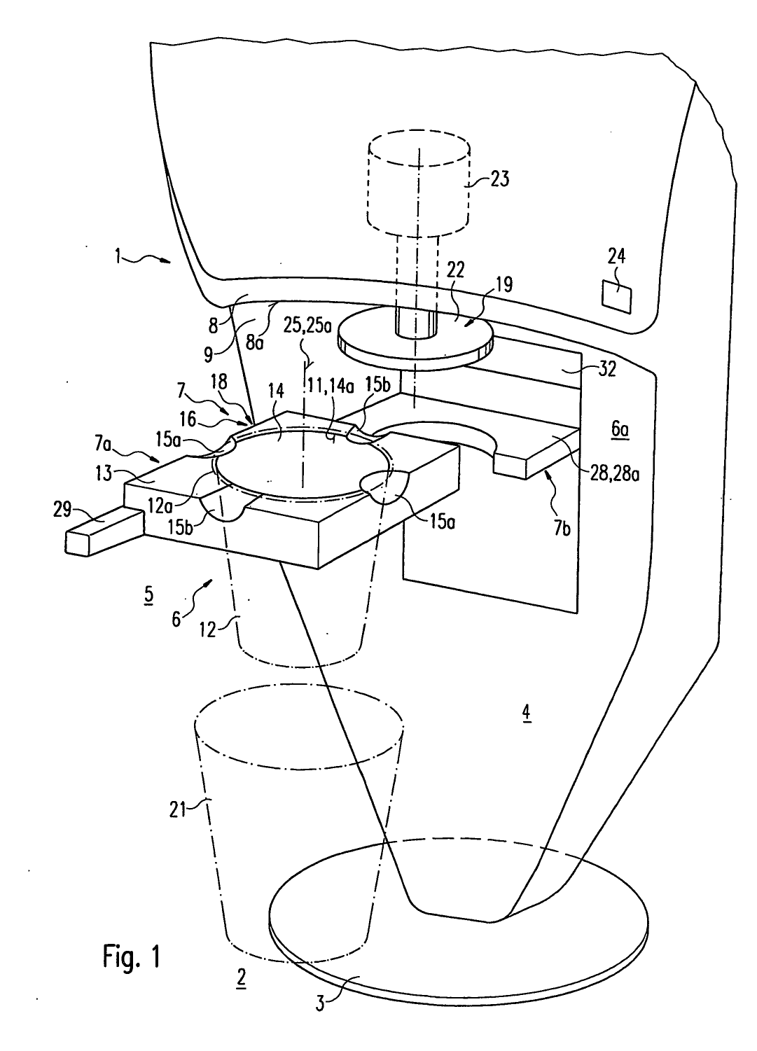

The dispensing device 7 comprises a holder 7a for a receiving container 12 (indicated in FIG. 1 by chain-dotted lines) for the foodstuff and a support 7b, which supports the holder 7a and is fastened to the housing 4 or to a frame (not illustrated) in the housing 4.

At least one holding element 11 for holding the receiving container 12, which is, for example, cup-shaped and is indicated only in FIG. 1, is arranged on the holder 7a. In the exemplary embodiment, the holder 7a has an annular body 13 which encloses a receiving hole 14 for the receiving container 12, into which the receiving container 12, which is shaped, for example, such that it diverges upwards, can be introduced from above. The receiving container 12 and the receiving hole 14 preferably have an essentially round cross-sectional shape, the receiving container 12 fitting with a clearance for movement into the receiving hole 14 and resting with an outer flange 12a, which is arranged on its upper edge, on the upper edge 14a of the receiving hole 14, which forms the holding element 11. In the exemplary embodiment, the receiving hole 14 is in a central position with respect to the annular body 13. The outer shape of the annular body 13 may be tetragonal or square, the annular body 13 and the holder 7a being in the form of a plate with an essentially flat upper and lower side. In order to be able to place the receiving container 12 in an easy-to-handle manner onto the holder 7a and also in order to be able to remove it from the holder 7a, two gripping clearances 15a, which are arranged lying opposite each other and are formed by recesses are provided on the upper side of the holder 7a and in which, when the receiving container 12 is being positioned in the holder 7a, two fingers of the operating hand grasping it on opposite sides can be placed, and the receiving container 12 can be advantageously deposited. To grasp and remove the receiving container 12, the two fingers can likewise grip into the gripping clearances 15a and remove the receiving container 12 in an easy-to-handle manner.

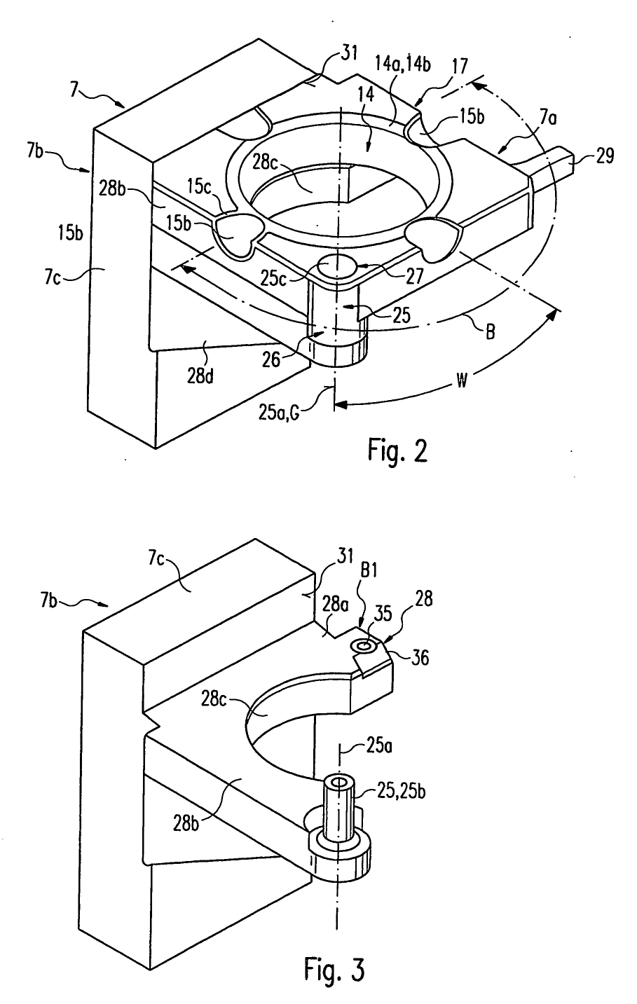

An adjusting device 16 is arranged between the support 7b and the holder 7a and makes it possible to move the holder 7a essentially horizontally relative to the support 7b between a delivery position 17 (illustrated in FIG. 2) and an intermediate position 18 (illustrated in FIG. 1). The delivery position 17 is situated in the central region of the recess 9 below the projection 8 and therefore close to the springing-back, vertical surface part 6a of the front side 6. The intermediate position 18 is offset horizontally with respect to the delivery position 17, so that it is more easily accessible to the operator. A region B (FIG. 2) is appropriate for this, the said region surrounding the delivery position in a curved manner from the one side across the operating side 5 to the other side of the delivery position 17 or of the housing 4. At each point of this region B, the intermediate position 18 is accessible in a simple and easy-to-handle manner. Particularly favourable positions for the intermediate position 18 are produced if the latter is offset with respect to the delivery position 17 towards the operating side 5, it also being possible for it to be offset laterally at the same time. With an offset of this type, the holder 7a is situated closer to the operating side 5 than the delivery position 17, with the result that the positioning of a receiving container 12 on the holder 7a is made substantially easier. The same also applies to the removal of the receiving container 12 from the holder 7a, which will also be described.

The receiving container 12 may be a package for the foodstuff, in particular ice cream, which, if appropriate after being opened, is positioned in the intermediate position 18 on the holder 7a and is moved together with the holder 7a into the delivery position 17. The delivery position 17 is assigned a discharging device 19 for discharging the receiving container 12 downwards. This enables the foodstuff to be pressed downwards out of the receiving container 12 and to be conveyed into a further receiving container 21, which may be, for example, a cup or a cone wafer, in which or with which the foodstuff is available for consumption.

In order to remove the receiving container 12, the holder 7a is firstly moved into the intermediate position 18, in which the receiving container 12 can be removed and disposed of in an easy-to-handle manner.

The discharging device 19 can be formed by a plunger 22 which is arranged coaxially with respect to the vertical central axis of the delivery position 17 and can be moved vertically between a starting position, which is situated above the receiving container 12 in the delivery position 17, and a discharging position, which dips into the receiving container 12, preferably as far as the base thereof, and back again. For this purpose, use is made of a drive 23 (illustrated by way of indication) in the housing 4 or in the projection 8. The plunger 22 is guided vertically in a guide (not illustrated) and can be moved down and up again by the drive 23. The discharging movement of the plunger 22 can be triggered by a switch (not illustrated), and it is automatically ended when the plunger 22 is in its upper starting position again.

In the exemplary embodiment, the adjusting device 16 is formed by the holder 7a being mounted in a manner such that it can pivot to and fro in a hinge 25 having an approximately vertically directed hinge axis 25a, the hinge axis 25a likewise being offset with respect to the delivery position 17 into the region B.

In one advantageous refinement of the exemplary embodiment, the hinge axis 25a is arranged on a straight line G which intersects the central axis of the delivery position and encloses, with the vertical central plane E of the dispensing device 7, an acute angle W of preferably approximately 45°.

The hinge 25 can be arranged on one or the other side with respect to the vertical central plane. For left-handed operation, the hinge 25 is situated on the left side. For right-handed operation, an arrangement on the right side is advantageous.

In the exemplary embodiment, the hinge axis 25a is situated in the region of a front and lateral corner 26 of the holder 7a in the intermediate position. It is formed by a hinge pin 25b which protrudes from one hinge part and is mounted rotatably in a hinge hole 25c arranged on the other hinge part. This forms a plug-in connection 27 which makes installation of the holder 7a possible by plugging it in from above and removal possible by removing it upwards. As a result, the holder 7a can be fitted and removed in an easy-to-handle manner and rapidly. This is particularly advantageous if the holder 7 is to be exchangable. A plurality of holders 7a are preferably assigned to the dispensing device 7 and are matched to different receiving containers 12. A specific exchange of the holders 7a therefore enables the dispensing device 7 to be matched to an appropriate receiving container 12 in each case, with the result that this receiving container 12 can be used appropriately and securely in the dispensing device 7. Different receiving containers 12 and holders 7a appropriate for them can be differentiated, for example, by the fact that the cross-sectional size or shape of the receiving container 12 and of the receiving hole 14 differs and is matched to one another.

Since the receiving container 12 is loaded downwards during the previously described squeezing out of the container contents, it is advantageous, additionally to the hinge 25, to arrange further supporting elements 28 on the support 7b which support the holder 7a in the delivery position 17, specifically preferably in a region B1 lying opposite the hinge 25. Effective supporting is provided if two supporting elements 28, for example the hinge 25 and the further supporting element 28, are provided lying opposite each other. In the exemplary embodiment, two supporting limbs 28a, 28b are provided, one of which is situated on the front side of the rear base part 7c of the support 7b. A supporting limb 28b is also provided which extends forwards from the base part 7c, supports the holder 7a on one side and in the front end region of which the hinge 25 is formed. A vertical recess 28c for the receiving container 12 in the delivery position 17 is provided in the front side of the supporting limb 28a. The supporting limb 28b can be stabilized by a corner plate 28d.

In the case of a hinge 25 which is offset forwards and laterally, the holder 7a executes the shape of a circular arc during its movement between the positions 17, 18, in which case the intermediate position 18 can be situated in the vertical central plane, as is also the case for the delivery position 17.

In the case of a rotatable holder 7a, it is advantageous to form, on its upper side, two further lateral gripping clearances 15b on both sides of the hole edge 14a, which facilitate the insertion or removal of the receiving container 12 in the delivery position 17. These gripping clearances 15b are rotated with respect to the gripping clearances 15a by the angle of rotation, here by an angle of rotation of 90°.

Edge breaks 14b, 15c can be provided on the hole edge 14a and on the edges of the gripping clearances 15a, 15b.

The receiving container 12 may be a package which is to be opened for the delivery, for example a casing.

To manually move the holder 7a between the delivery and intermediate positions 17, 18, it is advantageous to provide, at a distance from the hinge axis 25a, a gripping element 29 which can be grasped with the operating hand to move the holder 7a and is preferably arranged in the front region of the holder 7a. In the exemplary embodiment, the gripping element 29 is formed by a laterally protruding pin which is arranged on the side lying laterally opposite the hinge 25.

It is furthermore advantageous to assign to the holder 7a a stop 31 which limits its movement into the delivery position. In the exemplary embodiment, the stop 31 is formed by the rear part 7c protruding upwards over the rear supporting element 28 and thereby limiting the path of movement of the holder 7a on the rear side.

Furthermore, a means of securing it in the delivery position is expediently provided, for example by means of a releasable latch. In the exemplary embodiment, the supporting element 28 has, in the end region of the supporting limb 28a, a cam depression 34 into which a corresponding cam element (not illustrated) engages on the holder 7a after running over an entry slope 35, it also being possible for the cam element to be pretensioned. The engagement elements may also be assigned the other way around.

The rear part 7c is fastened to the housing 4 by a fastening device (not illustrated), it being possible for it to be positioned in a housing recess 32.

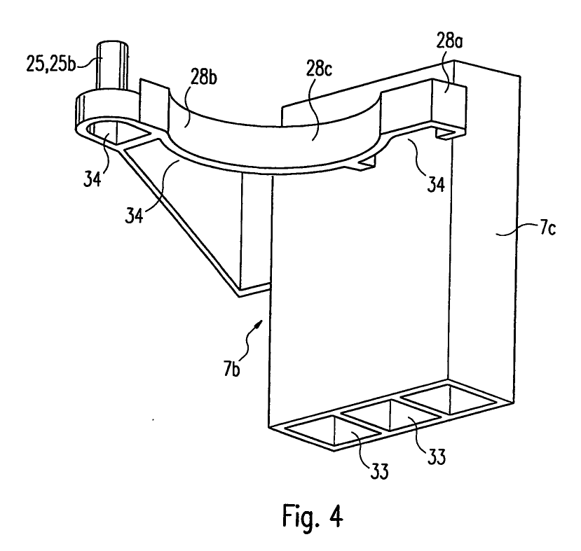

The holder 7a and the support 7b consist of a corrosion-resistant and preferably also lightweight material. A light metal or plastic is suitable for this. A hollow manner of construction is preferably also provided in order to save on material and weight. As can be seen in particular in FIG. 4, chambers 33, 34 which are open on the lower side are provided in the rear part 7c and in the supporting limbs.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. Dispenser comprising:
a holder for a container, the holder having a receiving opening in which the container is hanging, an outer flange of the container rests on an upper rim of the receiving opening, and
a plunger adapted to move in and out and pass through the receiving opening and into the container from above in order to dispense product at the lower end of the container.

2. Dispenser according to claim 1, wherein the cross-sectional dimension of the receiving opening is adapted to the cross-sectional dimension of the container such that there is a clearance between the side walls of the container and the rim of the receiving opening.

3. Dispenser according to claim 1, wherein the container is designed to be inserted into the receiving opening from above.

4. Dispenser according to claim 1, wherein the contour of the container has an upwardly divergent shape.

5. Dispenser according to claim 1, wherein the inner rim of the receiving opening has an annular recession in which the outer flange of the container rests such that an upper surface of the flange is flush with an upper surface of the holder.

6. Dispenser according to claim 1, wherein the plunger is designed to plunge downwards until it reaches the base of the container.

7. Dispenser according to claim 1, wherein the holder has the shape of a plate.

8. Dispensing device for a foodstuff, comprising a holder for a container, a support for the holder and a plunger adapted to pass into the container from above in order to dispense product at a lower end of the container;
the holder being connected to the support by an adjusting device and movable between a delivery position for delivering the foodstuff and an auxiliary position for inserting the container into and removing it from the holder.

9. Dispensing device according to claim 8, wherein the auxiliary position is offset with respect to the delivery position towards a region which surrounds the delivery position in a curved manner from one side over a front operating side towards the other side.

10. Dispensing device according to claim 9, wherein a removal position is offset with respect to the delivery position towards the front operating side.

11. Dispensing device according to claim 8, wherein the adjusting device has a rotary hinge with an approximately vertical axis of rotation which is offset with respect to the delivery position towards a region.

12. Dispensing device according to claim 11, wherein the axis of rotation is offset with respect to the delivery position laterally and/or towards the operating side.

13. Dispensing device according to claim 12, wherein the axis of rotation is arranged on a straight line which starts from the delivery position and extends obliquely to the left or right towards the operating side.

14. Dispensing device according to claim 11, wherein the holder has, on one side, an engagement element for a manual moving of the holder.

15. Dispensing device according to claim 14, wherein the engagement element is located on the front side of the holder that faces the operating side.

16. Dispensing device according to claim 14, wherein the engagement element is formed by a pin which protrudes from the holder.

17. Dispensing device according to claim 8, wherein the holder has an annular body which surrounds a receiving space for the container.

18. Dispensing device according to claim 17, wherein a cross-sectional size of the receiving space is matched with a clearance for movement to a cross-sectional size of the container and an upper edge of a receiving space supports a flange which is arranged on an upper edge of the container.

19. Dispensing device according to claim 8, wherein two mutually opposite gripping clearances are arranged in each case on an upper side of the holder in such a manner that they lie laterally opposite to each other in at least one of the auxiliary position or in the delivery position.

20. Dispensing device according to claim 8, wherein the support has, below the holder, a clearance for the container which is open towards a region.

21. Dispensing device according to claim 8, wherein the holder is supported, at least in the delivery position, with respect to a receiving space for the container at at least two mutually opposite points by supporting elements of the support.

22. Dispensing device according to claim 11, wherein the rotary hinge is located on a supporting arm which extends from a supporting body of the support towards an operating side and is offset laterally with respect to the delivery position.

23. Dispensing device according to claim 8, wherein the support has a stop for limiting a movement of the holder into the delivery position.

24. Dispensing device according to claim 8, wherein engagement elements are provided on the holder and support to releasably secure mutual positions in the delivery position.

25. A method for dispensing a product from a container, the method comprising the steps of:
inserting a container having an outer flange at its upper end in holding means having a receiving opening, such that the outer flange rests on the upper rim of the receiving opening, and
controlling a plunger to move in and out and pass through the receiving opening and to penetrate the container from above in order to dispense product at an outlet of the container provided at the lower end thereof.

26. Dispenser comprising:
a holder for a container, the holder having a receiving opening in which the container is hanging, an outer flange of the container rests on an upper rim of the receiving opening, and
a plunger for moving in and out of the receiving opening and the container from above in order to dispense product at the lower end of container.

27. Dispensing device for a foodstuff, comprising a holder for a container, and a support for the holder, the holder is connected to the support by an adjusting device and can be moved in the adjusting device between a delivery position for delivering the foodstuff and an auxiliary position for inserting the container into and removing it from the holder.

28. A method for dispensing a product from a container, the method comprising the steps of:
inserting a container having an outer flange at its upper end in holding means having a receiving opening, such that the outer flange rests on the upper rim of the receiving opening, and
controlling a plunger to penetrate the container from above in order to dispense product at an outlet of the container provided at the lower end thereof.

29. The dispenser of claim 1 wherein the product is ice cream.

30. The dispenser of claim 8 wherein the product is ice cream.

31. The dispenser of claim 26 wherein the product is ice cream.

32. The dispenser of claim 27 wherein the product is ice cream.

33. The dispensing device of claim 22 wherein the offset is laterally to the left.
